(19) United States
(12) Patent Application Publication
(10) Pub. No.: US 2013/0214686 A1
(43) Pub. Date: Aug. 22, 2013

(54) MONITORING DEVICE FOR MONITORING BRIGHTNESS OF DISPLAY

(71) Applicant: XIAO-LIAN HE, Shenzhen City (CN)

(72) Inventor: XIAO-LIAN HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/555,088

(22) Filed: Jul. 21, 2012

(30) Foreign Application Priority Data
Feb. 17, 2012 (CN) 201210035955.1

(51) Int. Cl. H05B 37/00

(52) U.S. Cl. 315/130

(57) ABSTRACT

A monitoring device includes a sensing element, a first switch element, a second switch element, and a warning unit. Brightness of a screen on a display unit is sensed by the sensing element. When the brightness of the screen on the display unit is not greater than a predetermined brightness, the first switch element will be turned on to turn on the second switch element so that the warning unit can be activated. Therefore, the display state of the screen can be monitored automatically.

### BACKGROUND

1. Technical Field

The present disclosure relates to a monitoring device, and particularly to a monitoring device for monitoring a display brightness.

2. Description of Related Art

When computers are tested for resistance to electromagnetic interference, screens of the computers might suffer interference and brightness of the screens might be lower. In addition, the screens may appear black and not displaying any images. Therefore, there should be some testing personnel to check display state of the screens during testing. This testing procedure consumes a lot of human resource.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a perspective view of a monitoring device of the present disclosure.

FIG. 2 is a front view of the monitoring device of the present disclosure.

FIG. 3 is a circuit diagram of a monitoring circuit in the monitoring device of the present disclosure.

FIG. 4 is an operating diagram of the monitoring device of the present disclosure.

### DETAILED DESCRIPTION

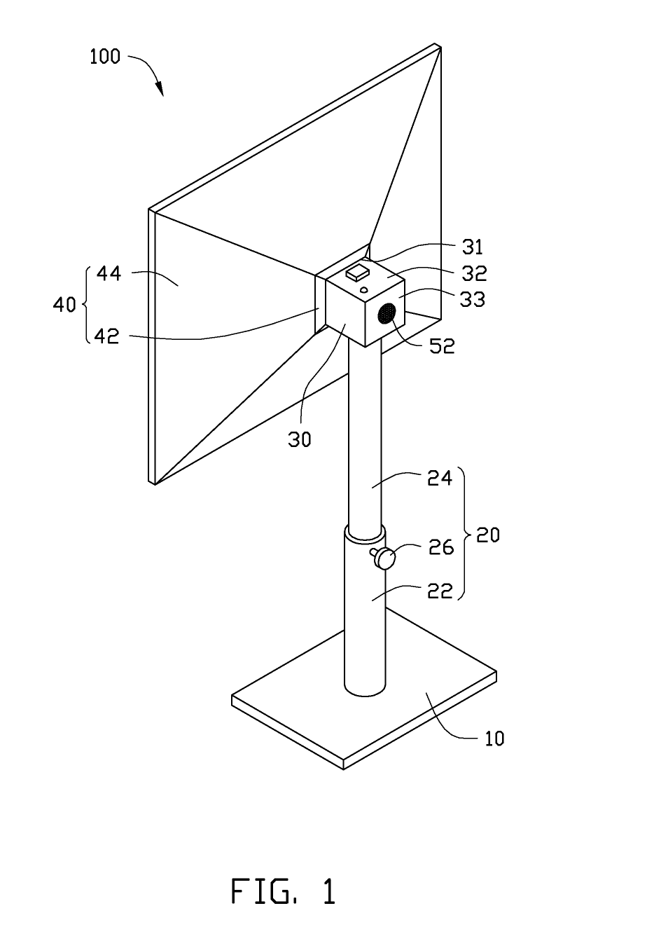

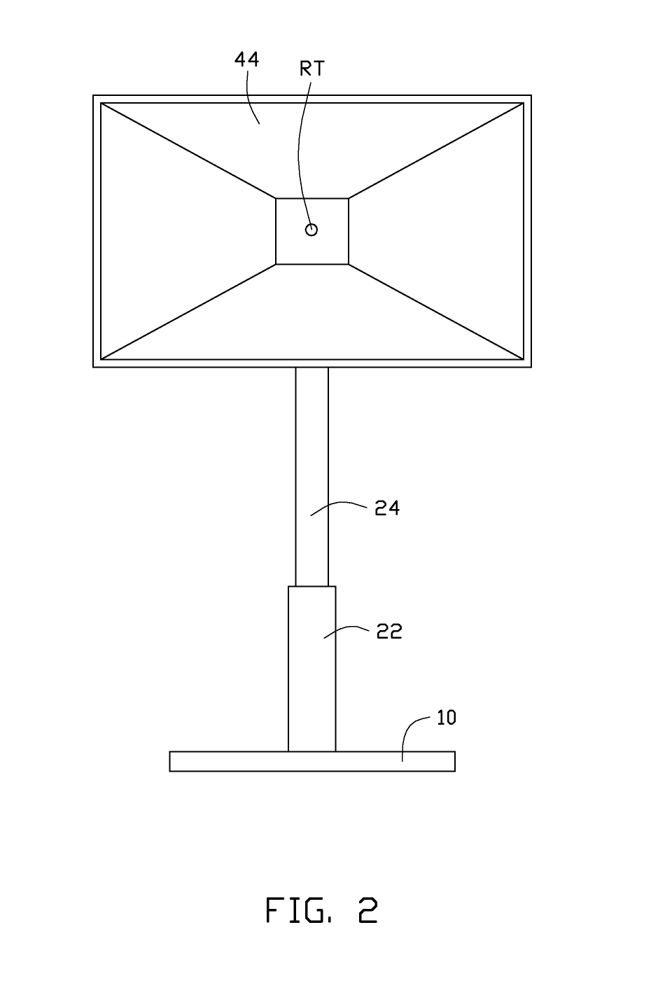

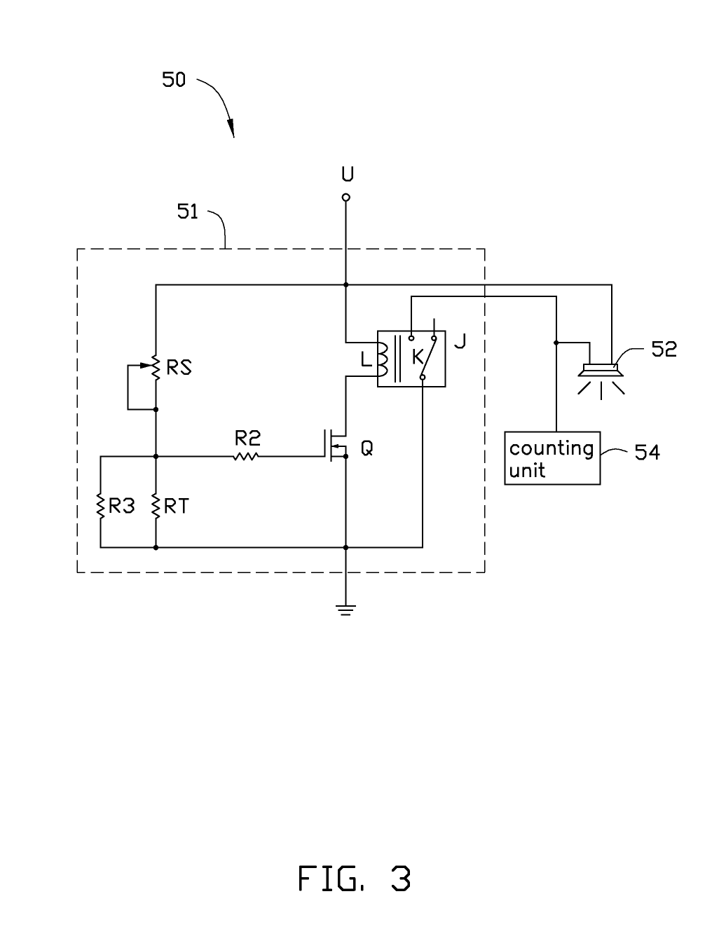

As shown in FIGS. 1 to 4, an embodiment of a monitoring device 100 includes a base 10, a support unit 20, a box 30, a collecting unit 40, and a monitoring circuit 50. The monitoring device 100 monitors a brightness of a screen 220 on a display unit 200 when the display unit 200 is being tested.

The support unit 20 includes a fixed support 22, a movable support 24, and a fixing component 26 and connects the box 30 to the base 10 for supporting the box 10. A first end of the fixed support 22 is fixed on the base 10, and a first end of the movable support 24 is inserted into the second end of the fixed support 22. A bottom portion of the box 30 is set on the second end of the movable support 24. The fixing component 26 is set on the fixed support 22 to fix the movable support 24 on the fixed support 22. The movable support 24 can be moved up or down in the fixed support 22 to adjust a height of the support unit 20. When the movable support 24 reaches an appropriate height, the fixing component 26 can be rotated clockwise to fix the movable support 24 in place.

The collecting unit 40 is a trumpet-shaped collecting box and collects light emitted from the display unit 200. The collecting unit 40 includes a bottom portion 42 and a collecting portion 44 extending outwardly from the bottom portion 42. The bottom portion 42 of the collecting unit 40 is set on a first side 31 of the box 30.

The monitoring circuit 50 includes a control circuit 51, a warning unit 52 and a counting unit 54. The control circuit 51 includes a sensing element RT, a first resistance element RS, a second resistance element R2, a third resistance element R3, a first switch element Q and a second switch element J. In the embodiment, the sensing element RT is a photosensitive element, such as a photoresistor, the first resistance element RS is a variable resistor, the second and the third resistance elements R2 and R3 are fixed-value resistors, the first switch element Q is an electronic switch, such as a transistor, the second switch element J is a relay, the warning unit 52 is an alarm, and the counting unit 54 is a counter.

The sensing unit RT is set on the bottom portion 42 of the collecting unit 40. The first resistance element RS is set in the box 30, wherein an adjusting terminal of the first resistance element RS can be exposed through the top 32 of the box 30 so that the user can easily adjust a resistance value of the first resistance element RS. The second and the third resistance elements R2 and R3, the first switch element Q, and the second switch element J are set in the box 30. The warning unit 52 is set on the second side 33 of the box 30, and the counting unit 54 is set on the top 32 of the box 30.

The sensing element RT and the first resistance element RS are connected in series between a direct current (DC) power unit U and ground. The third resistance element R3 is connected in parallel to the sensing element RT. The first switch element Q includes a first terminal, a second terminal, and a control terminal. A node between the sensing element RT and the first resistance element RS is connected to the control terminal of the first switch element Q through the second resistance element R2. The second switch element J includes a coil L and a switch K, wherein the coil L further includes a first terminal and a second terminal, and the switch K further includes a fixed contact, a normally open contact, and a normally closed contact. The first terminal of the first switch element Q is grounded, and the second terminal of the first switch element Q is connected to the first terminal of the coil L. The second terminal of the coil L is connected to the DC power unit U. The fixed contact of the switch K is grounded, the normally closed contact of the switch K is utilized as a free end, and the normally open contact of the switch K is connected to the counting unit 54 and to the warning unit 52. The warning unit 52 is further connected to the DC power unit U. In the embodiment, the first switch element Q is an N-type trench metal oxide semiconductor field effect transistor (MOSFET). The control terminal of the N-type trench MOSFET is a gate, the first terminal of the N-type trench MOSFET is a source, and the second terminal of the N-type trench MOSFET is a drain. In another embodiment, the first switch element Q can be a NPN-type transistor.

The sensing element RT senses the light and a resistance value of the sensing element RT changes according to a sensed brightness of the screen 220 of the display unit 200. In the embodiment, the resistance value of the sensing element RT decreases with increased brightness and increases with decreased brightness. That is, the resistance value of the sensing element RT decreases when the brightness of the screen 220 on the display unit 200 increases, while the resistance value of the sensing element RT increases when the brightness of the screen 220 on the display unit 200 decreases. In another embodiment, the resistance value of the sensing element RT can increase with increased brightness and decrease with decreased brightness.

The resistance value of the first resistance element RS is adjusted according to a predetermined resistance value of the sensing element RT corresponding to a predetermined brightness. A received voltage of the control terminal of the first switch element Q is controlled to be equal to a turned-on voltage of the first switch element Q when the sensed brightness is equal to the predetermined brightness. When the sensed brightness is less than the predetermined brightness, the resistance value of the sensing element RT is larger than the predetermined resistance value. Therefore, the received voltage of the control terminal of the first switch element Q is larger than the turned-on voltage of the first switch element Q, and the first switch element Q is turned on. When the sensed brightness is greater than the predetermined brightness, the resistance value of the sensing element RT is smaller than the predetermined resistance value. Thus, the received voltage of the control terminal of the first switch element Q is smaller than the turned-on voltage of the first switch element Q, and the first switch element Q is switched off. In the embodiment, the turned-on voltage can be a threshold voltage of the gate.

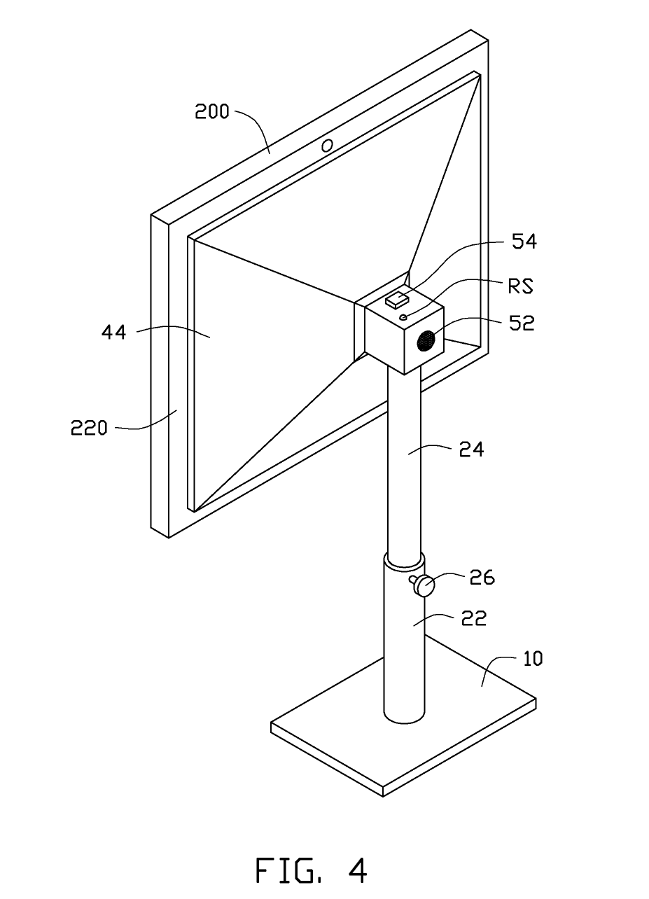

As shown in FIG. 4, the monitoring device 100 is set in front of the screen 220 of the display unit 200. The collecting portion 44 firmly abuts the screen 220 of the display unit 200 so that the light of the screen 220 on the display unit 200 is fully sensed by the sensing element RT and all other light is excluded, so the sensing element RT is not influenced by any external light. When the brightness of the screen 220 on the display unit 200 is greater than the predetermined brightness, the received voltage of the control terminal of the first switch element Q is smaller than the turned-on voltage of the first switch element Q so that the first switch element Q is switched off. Therefore, there is no current flowing through the coil L of the second switch element J so that the fixed contact of the second switch element J is connected to the normally closed contact. In other words, the second switch element J is switched off. Thus, the warning unit 52 is not activated and the counting unit 54 does not increase the count of times that the sensed brightness of the screen 220 is not larger than the predetermined brightness.

When the brightness of the tested display unit 200 is equal to or less than the predetermined brightness, the received voltage of the control terminal of the first switch element Q is larger than or equal to the turned-on voltage of the first switch element Q so that the first switch element Q is turned on. Therefore, current will flow through the coil L of the second switch element J so that the fixed contact of the second switch element J will be connected to the normally open contact. In other words, the second switch element J is turned on. Thus, the warning unit 52 will be activated to audible inform an operator that the brightness of the screen 220 on the display unit 200 is not greater than the predetermined brightness and the counting unit 54 will increase the count by one. When the brightness of the tested display unit 200 is greater than the predetermined brightness again, the first switch element Q is switched off so that the fixed contact is connected to the normally closed contact and the warning unit 52 stops issuing a warning. When the brightness of the tested display unit 200 is again not greater than the predetermined brightness, the first switch element Q is turned on so that the fixed contact is connected to the normally open contact, the warning unit 54 is activated, and the counting unit 54 increases the count by one. The monitoring device 100 continuously tests the display unit 200 in a time period according to the above test procedure.

The counting unit 54 is controlled by the second switch element J to count a number of times that the sensed brightness of the screen 200 is not greater than the predetermined brightness. In addition, since the starting number of the counting unit 54 is zero, a final number of the counting unit 54 represents the number of times that the brightness of the screen 220 on the display unit 200 is equal to or less than the predetermined brightness during the whole test procedure. Thus, test personnel can directly know the display state of the screen 220 on the display unit 200 according to the final number of the counting unit 54 and the time period. Furthermore, the monitoring device 100 can test a plurality of display units. Since each of the time periods for testing the display units can be the same, qualities of the screens on the display units can be directly known.

The monitoring device 100 senses the brightness of the display screen by the photoresistor. When the brightness of the screen on the display is equal to or less than the predetermined brightness, the N-type trench MOSFET is turned on to turn on the relay so that the alarm can be activated to audible inform an operator and the counter increases the count by one. Thus, it is unnecessary for the test personnel to be constantly on station. Accordingly, the test personnel can conveniently know the display state of the screen on the display.

While the disclosure has been described by way of example and in terms of various embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A monitoring device for monitoring a brightness of a display unit, comprising:
a collecting unit configured to collect light emitted from the display unit;
a control circuit, further comprising:
a sensing element configured in the collecting unit to sense the collected light;
a first switch element comprising a control terminal, a first terminal and a second terminal, wherein the first terminal is grounded, the control terminal is connected to the sensing element, and a received voltage of the control terminal is larger than or equal to a control voltage of the control terminal when a sensed brightness of the display unit is less than or equal to a predetermined brightness; and
a second switch element connected to the second terminal; and
a warning unit connected to the second switch element; wherein the first switch element is turned on to turn on the second switch element to activate the warning unit when the received voltage is larger than or equal to the control voltage.

2. The monitoring device of claim 1, wherein the control circuit further comprises a first resistance element and a ground, a power unit is externally connected to the control circuit, and the power unit, the first resistance element, the sensing element, and the ground are connected in series.

3. The monitoring device of claim 2, further comprising:
a base;
a box comprising a first side and a second side, wherein the collecting unit is configured on the first side of the box, the warning unit is configured on the second side of the box, and the first resistance element, the first switch element and the second switch element are configured in the box; and
a support unit connected the box to the base for supporting the box.

4. The monitoring device of claim 3, wherein the support unit further comprises:
a fixed support comprising a first end and a second end, wherein the first end is fixed on the base;
a fixing component configured on the fixed support; and
a movable support comprising a third end and a fourth end, wherein the third end is inserted into the second end, the fourth end is fixed on the box, and the movable support is moved in the fixed support and fixed by the fixing component.

5. The monitoring device of claim 3, wherein the collecting unit comprises a bottom portion and a collecting portion, the bottom portion is configured on the first side of the box, and the sensing element is configured at the bottom portion.

6. The monitoring device of claim 2, wherein the sensing element is a photosensitive element, the first resistance element is a variable resistor, and the warning unit is an alarm.

7. The monitoring device of claim 2, wherein the control circuit further comprises a second resistance element, wherein a node between the first resistance element and the sensing element is connected to the control terminal through the second resistance element.

8. The monitoring device of claim 2, wherein the second switch element is a relay comprising:
a coil connected to the second terminal and the power unit, and
a switch, further comprising:
a fixed contact grounded;
a normally closed contact configured as a free end, wherein the fixed contact is connected to the normally closed contact when the first switch element is switched off; and
a normally open contact connected to the warning unit, wherein the fixed contact is connected to the normally open contact to activate the warning unit when the first switch element is turned on.

9. The monitoring device of claim 1, wherein the first switch element is a field effect transistor, the control terminal is a gate, the first terminal is a source, and the second terminal is a drain.

10. The monitoring device of claim 1, further comprising:
a counting unit configured to be controlled by the second switch element to count a number of times that the sensed brightness of the display unit is less than or equal to the predetermined brightness.

11. A monitoring device for monitoring a display unit, comprising:
a sensing element configured to sense light emitted from the display unit;
a first switch element connected to the sensing element, wherein the first switch element is turned on when a sensed brightness of the display unit is less than or equal to a predetermined brightness;
a second switch element connected to the first switch element; and
a warning unit connected to the second switch element to activate when the first switch element is turned on to turn on the second switch element.

12. The monitoring device of claim 11, further comprising:
a collecting unit configured to collect the light emitted from the display unit, wherein the sensing element is configured in the collecting unit to sense the light.

13. The monitoring device of claim 11, the first switch element further comprising:
a first terminal grounded;
a second terminal connected to the second switch element; and
a control terminal connected to the sensing element, wherein a received voltage of the control terminal is larger than or equal to a control voltage of the control terminal when the sensed brightness is less than or equal to the predetermined brightness.

14. The monitoring device of claim 13, wherein the first switch element is turned on when the received voltage of the control terminal is larger than or equal to the control voltage of the control terminal.

15. The monitoring device of claim 11, wherein the sensing element is a photoresistor.
